(19) United States
(12) Patent Application Publication
(10) Pub. No.: US 2004/0135814 A1
(43) Pub. Date: Jul. 15, 2004

(54) Reading tool and method

(76) Inventor: George David Vendelin JR., Los Altos, CA (US)

Correspondence Address: HEWLETT-PACKARD COMPANY, Intellectual Property Administration, P.O. Box 272400, Fort Collins, CO, 80527-2400, US

(21) Appl. No.: 10/342,614

(22) Filed: Jan. 15, 2003

(51) Int. Cl. G09G 5/00

(52) U.S. Cl. 345/802; 345/803

(57) ABSTRACT

A method and apparatus providing a reading tool for enhancing reading and researching textual matter from an output device operatively interconnected to an input device and a computer system. The reading tool is defined in software configured to highlight a segment of textual matter with highlighting indicia through use of the input device and to move the highlighting indicia downward to highlight single subsequent segments of the textual matter in a sequential, manually controlled manner in real-time through use of the input device.

### FIELD OF THE INVENTION

The present invention relates generally to a reading tool and, more particularly, to a reading tool operatively interconnected to and useable with a computer system.

### BACKGROUND OF THE INVENTION

With the increasing use of computers, many problems associated with viewing text have arisen. In particular, prolonged reading from a screen of a computer display can cause eye strain and fatigue due to constant glare from the screen as well as discomfort from overhead lighting.

Numerous methods have been proposed in the past to reduce eye strain when viewing a computer display for prolonged periods of time. These methods include reducing the level of background and overhead lighting, consciously blinking frequently to keep the eyes moist and clean, maintaining regular breathing rates, and taking regular breaks. In the workplace, however, these methods are often impossible to achieve on a regular basis and are often impractical to implement.

Other problems relate to maintaining orientation while reading or researching one or more documents for extended periods of time, without skipping or repeating the same line and many times missing portions of research all together. Excessive glare on the computer display can further complicate screen orientation.

In addition to environmental distractions, there are often interruptions, which distract the viewer's attention, making it difficult to keep ones place in the document. Often it is simply necessary to leave the computer station. When returning to the document, one must usually search for the correct starting point. Such delays can be an annoyance and even adds stress to the task at hand. Often important information may be missed.

Reading and researching tasks are even more daunting when applied to multiple documents. For example, concurrent documents may be opened and displayed at any given time in most current computer operating systems. This is common in work-related projects or while researching a topic on the Internet. Trying to maintain organization and key points of reference between the various documents can be very difficult at times. When jumping back and forth through multiple documents or windows, it is easy to loose ones place. Interruptions and periodic distractions further complicate review of multiple documents.

### SUMMARY OF THE INVENTION

The present invention relates to a method and apparatus for providing a reading tool for reading text from an output device operatively interconnected to an input device and a computer system. The reading tool includes software which is operatively interconnected to the computer system and is to be controllable with the input device. The software is configured to highlight a segment of textual matter with highlighting indicia viewable on the output device through use of the input device. The software is also configured to move the highlighting indicia downward to highlight single subsequent segments of the textual matter in a sequential, manually controlled manner in real-time through use of the input device.

### BRIEF DESCRIPTION OF THE DRAWINGS

FIG. 1 illustrates a schematic diagram of a computer system having a computer display and software operable on the computer system, depicting an enlarged portion of the display to illustrate text as viewed by a viewer in conjunction with a reading tool defined in the software;

FIG. 2 illustrates, in flow chart form, an embodiment by which the reading tool can be implemented by a user;

FIG. 3 illustrates, in flow chart form, a continuation of FIG. 2 by which the reading tool can be implemented by a user; and

FIG. 4 illustrates, in flow chart form, a continuation of FIG. 3 depicting other embodiments by which the reading tool can be implemented by a user.

### DETAILED DESCRIPTION

Reference will now be made to the exemplary embodiments illustrated in the drawings, and specific language will be used herein to describe the same. It will nevertheless be understood that no limitation of the scope of the invention is thereby intended. Alterations and further modifications of the inventive features illustrated herein, and additional applications of the principles of the inventions as illustrated herein, which would occur to one skilled in the relevant art and having possession of this disclosure, are to be considered within the scope of the invention.

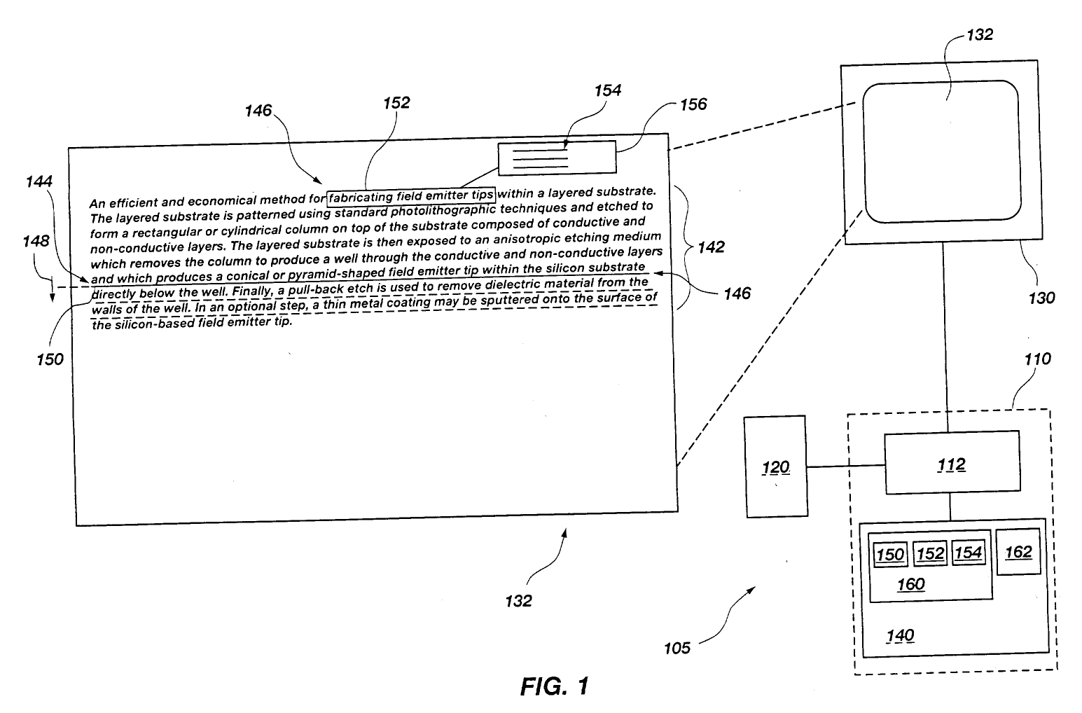

FIG. 1 illustrates an embodiment of a computer system 105 including a computer 110 operatively connected to an input device 120 and an output device 130. The computer 110 can include a desk-top computer or a lap-top computer, or another type of computer having a computer display configured with readable text. The computer 110 can include a processor device 112 operatively coupled to the input device 120 and the output device 130. The input device 120 can include a mouse, pointer device, keyboard or another type of input device suitable for inputting commands to the computer 110, such as manual touch-screen devices. The output device 130 includes a display 132 viewable by a reader. The output device 130 can include a computer monitor, flat screen LCD display, plasma screen or any other suitable display member operatively interconnected to the processor device 112 of the computer 110.

The computer system 105 is operatively interconnected to software 140. The software 140 can be located at a remote database or located on a database directly interconnected to the computer 110. The software 140 can include, among other types of software, an operating system 162 and a reading tool software 160 configured to provide a reading guideline 150, a reference accent 152 and/or highlighting notes 154. Such reading tool software 160 is configured to allow a user to operate the input device 120 while viewing text 142 on the output device 130 and to guide the user through reading the text 142 from the output device 130 in a manually controlled manner. The reading tool software 160 can also enable the user to highlight portions of the text 142 and provide annotations thereto.

The medium for supplying the reading tool software 160 can be in the form of a compact disc, hard drive or any suitable form so that the reading tool software 160 is functional with the computer system 105. The reading tool software 160 can also be located at a remote location interconnectable and downloadable via the Internet or a local network. Based on the various functions of the software which will be discussed in detail hereafter, such reading tool software 160 can be readily prepared and implementable with a computer system 105 by one of ordinary skill in the art.

The reading tool software 160 is configured to be implemented and function as a reading tool and can include, as previously set forth, a reading guideline 150. The reading guideline 150 is configured to function so as to allow a user to select a segment 144 of electronic text 142 viewable on the output device 130 of the computer system 105. Such a segment 144 can be a portion of a line, a line, multiple lines and/or any suitable portion of the text 142, which may depend on the user's preference and complexity of text material. The user can select the segment 144 of text 142 with the input device 120, such as for example, a line of text 142 that is displayed on a display 132 of the output device 130. By selecting such segment 144, the user highlights the segment 144 of text 142 with highlighting indicia 146. With this arrangement, the reading tool provides a reading guideline 150 so that the user can readily view, discern and read the highlighted portion of the segment 144. The user's eyes can more readily focus on the segment intended to be read. The user can then manually move the highlighting indicia 146 to the next segment 144 in the text 142, as indicated by arrow 148 and dashed lines in subsequent segments 144 in the text 142 at a pace desired. In this manner, the reading guideline 150 allows the user to readily follow the segments 144 in the text 142, manually selecting and manually moving in real-time, segment-to-segment, through the text 142 via the input device 120, without loosing track of the particular segment 144 that the user intends to read. An important aspect of the present invention includes the ability of the user to manipulate the reading guideline and other features selectively and in a manually controlled manner.

Manually controlled manner is characterized by real-time control and selection of reading parameters. Such parameters can include manually selecting a text segment 144 within the text 142 with a segment size chosen by the user. Further, parameters can include manually moving the segment 144 to subsequent segments 144 at a rate comfortable to the user, wherein each advancing segment 144 can be moved with manual real-time control which can be variable control or a variable rate at a reading rate comfortable to the user. Advancing to subsequent segments 144 can be employed with the input device 120, such as for example, through the mouse, the pointer device, through commands on the keyboard, such as a tab key, function keys, arrow keys, etc. In this manner, the reading guideline 150 assists the user to automatically maintain the user's position in the text 142 and help focus the user's eyes, thereby, potentially alleviating strain and fatigue to the user's eyes.

In another embodiment, the reading tool software 160 can be configured to include a reference accent 152 feature. Such a reference accent 152 can be configured to maintain a highlighted portion over a desired portion of text 142 in one or more documents being displayed on the output device 120. The reference accent 152 can be helpful to a user that may be reading and/or researching different pages of text 142 from various sources, such as different Web sites, and/or text documents located in a database, locally or remotely. Further, a user may be reading over a text document and would like to mark various positions of a particular document for quick and easy reference to such positions. In this manner, the reference accent 152 can be utilized on multiple documents or a single document, wherein the reference accent 152 can facilitate providing a highlighted mark via highlighting indicia 146 that can be maintained in the text 142 while the user continues reading from segment-to-segment with the reading guideline 150.

In another embodiment, the reading tool software 160 can be configured to include a highlighting notes 154 feature. The highlighting notes 154 feature can be configured to allow a user to provide comments, remarks and cross-references that may be added to particular desired portions of a text document and then can be edited if desired. Such highlighting notes 154 feature can work in conjunction with the reference accent 152 feature to provide easy locating and referencing ability to desired portions of text 142 on one or more electronic documents or multiple portions on a single electronic document. It is contemplated that such highlighting notes 154 can be added in, for example, a mini-window 156 positionable adjacent a portion of text 142 desired by the user, or any other suitable method, such as in footnote-type form. Thus, the reading tool implementable through the reading tool software 160 can include a reading guideline 150 for guiding a user while reading, a reference accent 152 for reference marking portions of the text 142 for easy retrieval, and highlighting notes 154 for the user to input comments and remarks as desired by the user.

Depending on the preference of the user, the reading tool software 160 is configured to provide various forms of highlighting indicia 146. Such various forms of highlighting indicia 146 can include any suitable form for highlighting a segment 144 of text 142. For example, the highlighting indicia 146 can include underlining the segment 144, encircling the segment 144, changing the text lettering of the segment 144 to bold or italics, changing the lettering to a different color and/or block highlighting of the text lettering, and combinations thereof, or any other suitable means of highlighting the segment 144 of text 142 that make such segment distinguishable from the un-highlighted portions of the text 142 viewable on the display 132.

As desired, the user can change between the various forms of highlighting indicia 146 so that the user can utilize one type of highlighting indicia 146 when used with the reading guideline 150, another type of highlighting indicia 146 when used with the reference accent 152, and another type of highlighting indicia 146 while using the highlighting notes 154 feature. Such various forms of highlighting indicia 146 will allow the user to readily distinguish and locate desired portions of the text 142 in one or more text documents by association, thereby, assisting the user to locate desired portions of text for reference and review more quickly and efficiently.

In this manner, allowing the user to manipulate the various forms of highlighting indicia 146 with the reference accent 152 feature and the highlighting notes 154 feature can enhance the memory of the user when a user is faced with the daunting task of reading through multiple pages of text 142 and researching multiple text documents. Further, the reading tool software 160 provides the reading guideline 150 to help the user focus the user's eyes on the segments of text highlighted by the highlighting indicia 146, to thereby, alleviate strain and fatigue to the user's eyes. Otherwise, the eyes tend to view a larger section of the text document, requiring greater mental energy to evaluate the material therein.

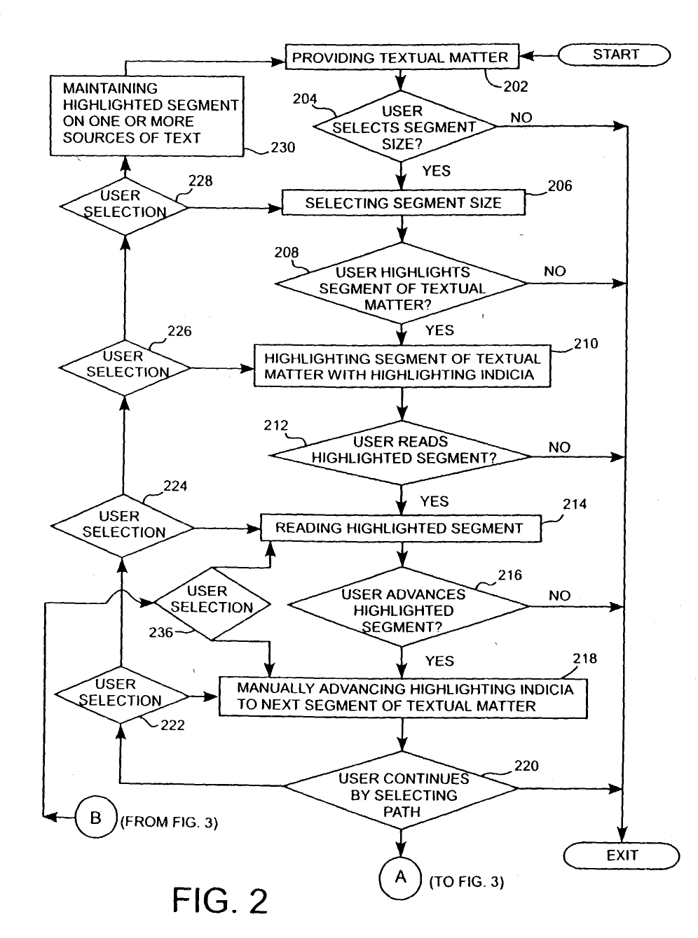

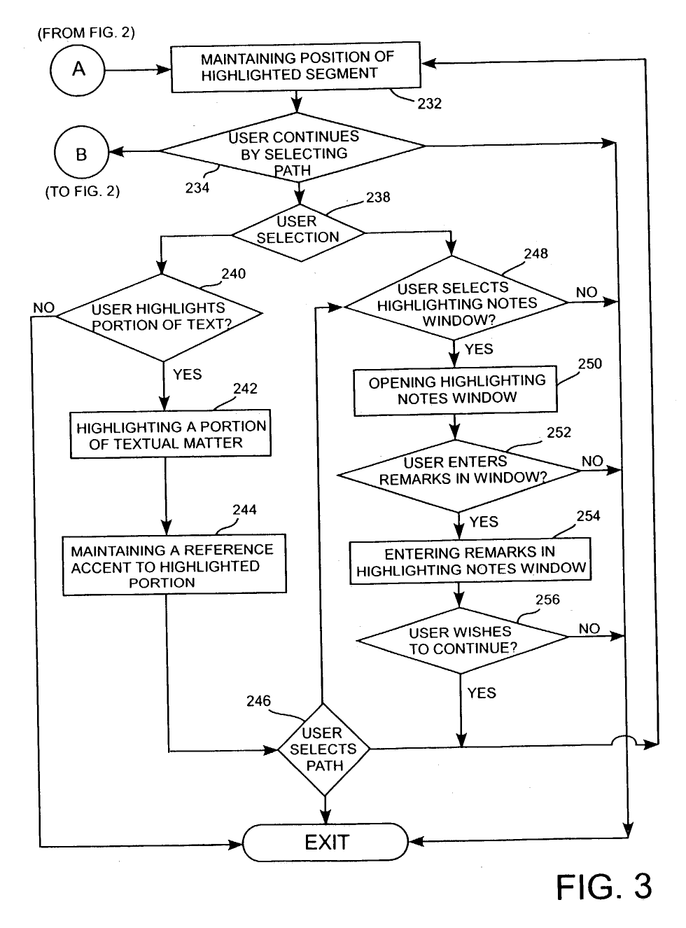

FIG. 2 illustrates a flow diagram of an embodiment by which the reading guide line 150 associated with the reading tool software 160 can be employed with a computer system 105. With reference to FIGS. 1 and 2, a user first provides textual matter viewable on an output device 130 as indicated in block 202. Such textual matter can be any type of text readable and viewable on the display 132 of the output device 130, such as text from various word processing programs, text from a Web site from the Internet, or any suitable electronic textual matter. As indicated in user decision block 204, the user can either choose to continue or discontinue. If the user chooses to discontinue, then the user can exit. If the user chooses to continue, the user proceeds to user input block 206 and selects a segment size of the text 142. Once the user selects the segment size, the user can either choose whether to highlight the text 142 with the corresponding previously chosen segment size or choose to discontinue, as indicated in decision block 208. If the user chooses to discontinue, the user can exit. Otherwise, the user can proceed by highlighting the segment 144 of text 142 with highlighting indicia 146 with the input device 120 as indicated in user input block 210. As indicated in user decision block 212, the user can either discontinue by exiting or proceed to the next block of reading the highlighted segment 144 of text 142 as indicated in block 214. After reading the segment 144 of text 142, the user can choose either to exit or continue by advancing the highlighting indicia 146 as indicated by user decision block 216. If the user chooses to continue by advancing the highlighting indicia 146, the user manually advances the highlighting indicia 146 with the input device 120 to the next segment 144 of text 142 as indicated in user input block 218.

At this juncture, as indicated in user selection block 220, the user can continue by selecting one of three paths: one, the user can proceed to exit; two, the user can simply maintain the position of the highlighted segment as indicated in block 232 (FIG. 3); or, three, the user can proceed to user selection blocks 222, 224, 226 and 228. At user selection block 222, the user can either proceed to manually advance the highlighting indicia 146 to the next segment 144 of text 142 as indicated in user input block 218 or proceed to user selection block 224. At user selection block 224, the user can either proceed by reading the current highlighted segment 144 as indicated in block 214 or proceed to user selection block 226.

By proceeding to block 214, the user completes one of the feed-back loops in the flow chart. With this feed-back loop, the user can repeat blocks 214 and 218 to manually manipulate the reading guideline 150 segment-to-segment through the text 142 via the input device 120, thereby, allowing the user to readily follow the highlighting indicia 146 in the text 142 so that the user manually advances the highlighting indicia 146 through the text 142 at a variable reading rate and pace desired by the user.

In the case where the user proceeds to user selection block 226, the user may choose to proceed to another portion of the text 142 and re-select a segment of text by highlighting the segment of text with the highlighting indicia 146 as indicted in user input block 210. The user can then proceed from the re-selected segment of text through blocks 212, 214, 216, 218 as previously set forth. The user can also proceed from user selection block 226 by proceeding to the next user selection block 228. At user selection block 228, the user can proceed to user input block 206 in the case where, for example, the user desires to change the segment size in the text that is highlighted by the highlighting indicia 146. The user can then proceed with the new segment size through the subsequent blocks 208, 210, 212, 214, 216, 218 as previously set forth.

Also, at user selection block 228, the user can proceed by maintaining the position of the highlighted segment on the particular text as indicated in block 230. While maintaining the highlighted segment in the text 142, the user can then proceed back to user input block 202 of providing textual matter. At this juncture, the user can proceed by providing another text document or proceed to another portion of the text in the current text document. With the new text document or the new portion of the current text document, the user can proceed from block 202 through the subsequent blocks 204, 206, 208, etc. as previously set forth. In this manner, the reading guideline 150 can be utilized at multiple locations in a single document and/or in multiple different documents of text while maintaining the reading guideline 150 at the position last read by the user in each text document and/or each portion of a single text document.

Referring back to user selection block 220, the user can proceed to block 232 in FIG. 3, in which the user can maintain the position of the highlighted segment in the text for a period of time desired by the user. The user can then proceed, as indicated in user selection block 234 by exiting, continuing to user selection block 236 (FIG. 2), and/or proceeding to user selection block 238. In the case where the user continues to user selection block 236 (FIG. 2), the user can either read the highlighted segment in block 214 or manually advance the highlighting indicia to the next segment as indicated in user input block 218. Such a situation of maintaining the position of the highlighted segment in block 232 in FIG. 3 and then proceeding to user selection block 234 and then to user selection block 236 (FIG. 2) can result in cases where the user is distracted and responds to such distraction. For example, the user may desire to stop reading and move to another project. The position of the highlighted segment in the text is maintained during this period of time. Once the user desires to return, the user can readily retrieve the reading position in the text with the highlighted segment marking such reading position. The user can then proceed from block 232 as previously indicated.

In the case where the user proceeds to user selection block 238 in FIG. 3 from user selection block 234, the user can access the reference accent 152 feature and the highlighting notes 154 feature in the reading tool software 160. With reference to both FIGS. 1 and 3, at user selection block 238, the user can proceed to either block 240 for accessing the flow path for the reference accent 152 feature or block 248 for accessing the flow path for the highlighting notes 154 feature. In the case where the user proceeds to block 240, the user can either exit or proceed by highlighting a portion of desired text with highlighting indicia 146 as indicated by user input block 242. The user can then maintain a reference accent 152 to the desired portion of text 142 with the highlighting indicia 146 as indicated in block 244.

At this juncture, the user can then proceed to user selection block 246, by which the user can select one of three paths: one, the user can exit; two, the user can proceed to the reading guideline 150 at the previously maintained position of the highlighted segment indicated in block 232; and three, the user can proceed to user decision block 248, which is also accessible from user selection block 238 as previously indicated. At user decision block 248, the user can either proceed by exiting or proceed in opening the highlighting notes window 156 as indicated in user input block 250. The user then proceeds to user decision block 252, wherein the user can either proceed by exiting or the user can proceed by entering remarks in the window as indicated in user input block 254. With this arrangement, the highlighting notes 154 can be disposed in the text 142 and, if desired, can be disposed adjacent the portion of text highlighted with the reference accent 152. The remarks entered by the user can therefore be preserved for the user to reference and provide additional help to the user's memory when reading and reviewing through the text document.

After utilizing the highlighting notes 154 feature, the user can then proceed by either exiting or proceeding to the previously maintained position of the highlighted segment indicated in block 232, which is also accessible from user selection block 246 as previously indicated. The user can then proceed as previously set forth in user decision block 234.

It is to be understood that the above-referenced arrangements are illustrative of the application for the principles of the present invention. Numerous modifications and alternative arrangements can be devised without departing from the spirit and scope of the present invention while the present invention has been shown in the drawings and described above in connection with the exemplary embodiments of the invention. It will be apparent to those of ordinary skill in the art that numerous modifications can be made without departing from the principles and concepts of the invention as set forth in the claims.

What is claimed is:

1. A reading tool for reading text from an output device operatively interconnected to an input device and a computer system, the reading tool comprising:
software configured to be operatively interconnected to the computer system and configured to be controllable with the input device, said software configured to highlight a segment of textual matter with highlighting indicia viewable on the output device through use of the input device, said software configured to move said highlighting indicia downward to highlight single subsequent segments of said textual matter in a sequential, manually controlled manner in real-time through use of the input device.

2. The reading tool of claim 1, wherein said segment of said textual matter is selected from the group consisting of: a portion of a line; a line; multiple lines; and, a portion of text.

3. The reading tool of claim 1, wherein said software is configured to maintain said highlighting indicia at a position of one of said single subsequent segments of said textual matter for a period of time while awaiting a further manual command to advance to a subsequent segment.

4. The reading tool of claim 1, wherein said software is configured to maintain a reference accent to a portion of said textual matter with said highlighting indicia.

5. The reading tool of claim 4, wherein said reference accent to said portion of said textual matter comprises another highlighting indicia distinguishable from said highlighting indicia used to highlight said single subsequent segments of said textual matter moved downward in said sequential, manually controlled manner.

6. The reading tool of claim 1, wherein said software is configured to include highlighting notes to said textual matter.

7. The reading tool of claim 1, wherein said highlighting indicia comprises at least one indicia selected from the group consisting of: underlining indicia; italicized indicia; bold indicia; encircling indicia; coloring indicia; and, block highlighting indicia.

8. The reading tool of claim 1, wherein said software is configured to highlight said textual matter viewable on the output device taken from multiple sources including at least one of a local location and one of a remote location.

9. The reading tool of claim 1, wherein the input device comprises at least one device selected from the group consisting of: a mouse; a pointing device; and, a keyboard.

10. The reading tool of claim 1, wherein the output device comprises a computer display.

11. The reading tool of claim 1, wherein said sequential, manually controlled manner comprises variable control of reading rates in real-time.

12. A method of forming software to enhance reading text from an output device operatively interconnected to an input device and a computer system, the method comprising:
providing software configured to be operatively interconnected to the computer system and configured to be controllable with the input device;
configuring said software to highlight a segment of textual matter with highlighting indicia viewable on the output device through use of the input device; and
configuring said software to move said highlighting indicia downward to highlight single subsequent segments of said textual matter in a sequential, manually controlled manner in real-time through use of the input device.

13. The method of claim 12, wherein said configuring said software to highlight comprises configuring said software to highlight said segment of said textual matter selected from the group consisting of: a portion of a line; a line; multiple lines; and, a portion of text.

14. The method of claim 12, further comprising configuring said software to maintain said highlighting indicia at a position of one of said single subsequent lines of said textual matter for a period of time while awaiting a further manual command to advance to a subsequent segment.

15. The method of claim 12, further comprising configuring said software to maintain a reference accent to a portion of said textual matter with said highlighting indicia.

16. The method of claim 15, wherein said configuring said software to maintain said reference accent comprises configuring said software to maintain said reference accent with another highlighting indicia distinguishable from said highlighting indicia used to highlight said single subsequent segments of said textual matter moved downward in said sequential, manually controlled manner.

17 The method of claim 12, further comprising configuring said software to include highlighting notes to said textual matter.

18. The method of claim 12, wherein said configuring said software to highlight comprises configuring said software to provide said highlighting indicia including at least one indicia selected from the group consisting of: underlining indicia; italicized indicia; bold indicia; encircling indicia; coloring indicia; and, block highlighting indicia.

19. The method of claim 12, wherein said configuring said software to highlight a line of textual matter comprises configuring said software to highlight said textual matter viewable on the output device taken from multiple sources including at least one of a local location and one of a remote location.

20. The method of claim 12, further comprising configuring said software to respond to commands with the input device including at least one device selected from the group consisting of: a mouse; a pointing device; and, a keyboard.

21. The method of claim 12, further comprising configuring said software to be functional with the computer system and viewable on the output device including a computer display.

22. The method of claim 12, wherein said configuring said software to move said highlighting indicia downward comprises configuring said software to move said highlighting indicia downward in said sequential, manually controlled manner with variable control of reading rates in real-time through use of the input device.

23. A method of reading text with a reading tool on an output device interconnected to an input device and a computer system, the method comprising:
providing textual matter to the output device viewable by a reader;
selecting a segment size for viewing said textual matter with highlighting indicia through the input device;
highlighting a segment of said textual matter;
reading said segment of said textual matter;
manually advancing said highlighting indicia to a next adjacent segment of said textual matter; and
repeating any one of the preceding sequence of steps.

24. The method of claim 23, further comprising the additional steps of:
maintaining said highlighting indicia at a position of one of said next adjacent segments of said textual matter for a period of time; and
returning to said reading by viewing the highlighted segment previously maintained.

25. The method of claim 23, further comprising maintaining said highlighting indicia at a segment position of said textual matter on one or more text sources to be viewed on said output device.

26. The method of claim 24, further comprising:
highlighting a portion of said textual matter; and
maintaining a reference accent to said portion of said textual matter with said highlighting indicia.

27. The method of claim 24, further comprising:
opening a window configured for entering remarks therein; and
maintaining said remarks to said textual matter as highlighting notes.

28. The method of claim 23, wherein said selecting said line comprises selecting highlighting indicia including at least one indicia selected from the group consisting of: underlining indicia; italicized indicia; bold indicia; encircling indicia; coloring indicia; and, block highlighting indicia.

29. A means for guiding a reader reading through text from an output device operatively interconnected to an input device and a computer system, comprising:
highlighting means for highlighting a segment of textual matter with highlighting indicia viewable on the output device through use of the input device; and
guiding means for guiding the reader through said textual matter, said guiding means manually controllable by the reader by advancing said highlighting indicia downward to highlight single subsequent segments of said textual matter in a sequential, manually controlled manner in real-time through use of the input device.
